(19) United States
(12) Patent Application Publication
(10) Pub. No.: US 2024/0326393 A1
(43) Pub. Date: Oct. 3, 2024

(54) MULTILAYER FILM, MULTILAYER BODY, PACKAGE AND PACKAGED ARTICLE

(71) Applicant: MITSUBISHI CHEMICAL CORPORATION, Tokyo (JP)

(72) Inventor: Hiroto YAMADA, Ogaki-shi (JP)

(73) Assignee: MITSUBISHI CHEMICAL CORPORATION, Tokyo (JP)

(21) Appl. No.: 18/678,105

(22) Filed: May 30, 2024

Related U.S. Application Data
(63) Continuation of application No. PCT/JP2022/035541, filed on Sep. 22, 2022.

(30) Foreign Application Priority Data
Dec. 3, 2021 (JP) 2021-197137

(51) Int. Cl. B32B 27/08; B32B 27/32; B32B 27/36; B32B 33/00

(52) U.S. Cl. CPC B32B 27/08; B32B 27/32; B32B 27/36; B32B 33/00; B32B 2255/10; B32B 2255/26; B32B 2307/75

(57) ABSTRACT

A laminate film having at least a base layer and a sealant layer in which: the sealant layer is composed of a resin composition containing a thermoplastic elastomer (B) as the main component; the thermoplastic elastomer (B) contains a styrene unit; and the sealant layer further contains a crosslinker (C). According to the present invention, a laminate film having excellent suitability for thermal lamination and excellent humidity and heat resistance can be provided.

### TECHNICAL FIELD

The present invention relates to a laminate film, a multilayer body, a packaging material and a packaged article.

### BACKGROUND ART

Liquid toners attract attention as techniques for printing on a container package of a beverage, a food, an article of daily use or the like. A liquid toner is known to be capable of developing a color with a thinner film than those of conventional toners and capable of increasing the resolution of the printed image.

A polymer having an ionic group is used as a material so that a liquid toner has electrostatic property.

For example, PTL 1 proposes a liquid toner obtained by adding a pigment to a polymer having a maleic anhydride functional group and an ethylene methacrylic acid copolymer and dispersing the mixture in a paraffinic hydrocarbon fraction. The liquid toner exhibits excellent binding property due to the interaction between the carboxy group contained in the maleic anhydride and the hydroxy group of the base paper.

### CITATION LIST

### Patent Literature

PTL 1: JP 2003-520997 A

### SUMMARY OF INVENTION

### Technical Problem

A printed matter obtained using a liquid toner, however, sometimes deteriorates or deforms in a humid and hot environment such as a retort. The water resistance can be improved by thermally laminating a protecting film on the printed matter, but the resistance to a highly humid and hot environment is insufficient.

Thus, an object of the present invention is to provide a laminate film having excellent suitability for thermal lamination and excellent humidity and heat resistance (retort resistance).

### Solution to Problem

The present inventor has repeated extensive studies to achieve the object and, as a result, completed the present invention. That is, the summary of the present invention is as follows.
[1] A laminate film having at least a base layer and a sealant layer, wherein the sealant layer is composed of a resin composition containing a thermoplastic elastomer (B) as the main component, the thermoplastic elastomer (B) contains a styrene unit, and the sealant layer further contains a crosslinker (C).
[2] A laminate film having at least a base layer and a sealant layer, wherein the sealant layer is composed of a resin composition which satisfies (1) and (2) below.
(1) The storage modulus at 50° C. is 2.0×10⁶ Pa or more and 5.0×10⁷ Pa or less.
(2) The slope of the storage modulus at 60 to 70° C. is 9.5×10⁻² or less.
[3] The laminate film according to [2] above, wherein the resin composition contains a thermoplastic elastomer (B).
[4] The laminate film according to [2] or [3] above, wherein the sealant layer further contains a crosslinker (C).
[5] The laminate film according to any of [1] to [4] above, wherein the base layer contains a thermoplastic resin (A).
[6] The laminate film according to [1], [4] or [5] above, wherein the crosslinker (C) is an epoxy crosslinker.
[7] The laminate film according to any of [1] and [3] to [6] above, wherein the thermoplastic elastomer (B) content of the resin composition is 50 mass % or more and 100 mass % or less.
[8] The laminate film according to according to any of [1] to [7] above, wherein the thickness of the base layer is 5 μm or more and 50 μm or less.
[9] The laminate film according to any of [1] to [8] above, wherein the thickness of the sealant layer is 1 μm or more and 30 μm or less.
[10] The laminate film according to any of [5] to [9] above, wherein the thermoplastic resin (A) is at least one kind selected from the group consisting of a polyester resin and a polyolefin resin.
[11] The laminate film according to any of [1] and [3] to above, wherein the thermoplastic elastomer (B) has an acidic functional group and has an acid value of 1 mg CH₃ONa/g or more and 100 mg CH₃ONa/g or less.
[12] The laminate film according to any of [1] and [3] to above, wherein the thermoplastic elastomer (B) is a hydrogenated conjugated diene polymer.
[13] The laminate film according to above, wherein the conjugated diene polymer is styrene-butadiene rubber or styrene-isoprene rubber.
[14] The laminate film according to any of [1] to above which has a primer layer between the sealant layer and the base layer.
[15] A multilayer body having the laminate film according to any of [1] to above and a print layer, wherein the laminate film is thermally laminated on the print layer.
[16] The multilayer body according to above, wherein the print layer is formed with a liquid toner.
[17] The multilayer body according to above, wherein the liquid toner contains a carboxy group-containing polymer.
[18] A multilayer body having a laminate film having at least a base layer and a sealant layer and a print layer, wherein the sealant layer and the print layer are in contact with each other, the sealant layer contains a crosslinker, the print layer contains a liquid toner, the liquid toner contains a polymer having an ionic group, and the multilayer body has a cross-linked structure of the crosslinker and the ionic group.
[19] A packaging material having the multilayer body according to any of to above.
[20] A packaged article packaged with the packaging material according to above.

### Advantageous Effects of Invention

The laminate film proposed in the present invention has excellent suitability for thermal lamination and excellent humidity and heat resistance (retort resistance).

### BRIEF DESCRIPTION OF DRAWINGS

FIG. 1 is a graph showing the measurement results of the storage moduli of the resin compositions of the Examples and the Comparative Examples.

### DESCRIPTION OF EMBODIMENTS

Embodiments of the present invention will be explained in detail below. In this regard, however, the contents of the present invention are not limited to the embodiments explained below.

### <Laminate Film>

A first embodiment of the present invention is a laminate film having at least a base layer and a sealant layer in which: the sealant layer is composed of a resin composition containing a thermoplastic elastomer (B) as the main component; the thermoplastic elastomer (B) contains a styrene unit; and the sealant layer further contains a crosslinker (C).

The first embodiment of the present invention is preferably a laminate film having at least a base layer and a sealant layer in which: the base layer contains a thermoplastic resin (A) as the main component; the sealant layer is composed of a resin composition containing a thermoplastic elastomer (B) as the main component; the thermoplastic elastomer (B) contains a styrene unit; and the sealant layer further contains an epoxy crosslinker (C).

A second embodiment of the present invention is a laminate film having at least a base layer and a sealant layer in which the sealant layer is composed of a resin composition which satisfies (1) and (2) below.
(1) The storage modulus at 50° C. is 2.0×10⁶ Pa or more and 5.0×10⁷ Pa or less.
(2) The slope of the storage modulus at 60 to 70° C. is 9.5×10⁻² or less.

The laminate film in the present invention (sometimes referred to as “the present film” below) has at least a base layer and a sealant layer. The sealant layer is provided on at least one surface of the base layer. The sealant layer may be layered directly on the surface of the base layer, or another layer may be appropriately provided between the sealant layer and the base layer. In view of the adhesion between the layers, a primer layer is preferably provided between the sealant layer and the base layer.

The present film may have a release layer on the sealant layer on the side opposite to the surface facing the base layer.

The sealant layer preferably forms an outer surface of the present film when no release layer is included, and the sealant layer is preferably a layer which is in direct contact with the release layer when a release layer is provided.

For the purpose of adding further function, a multilayer structure having at least one layer selected from a protecting layer, an antireflection layer, an antibacterial layer, a smooth layer, a hardcoat layer and the like may also be used. When the present film has a multilayer structure, however, the number of the layers except for the base layer, the sealant layer and the release layer is preferably five or less in view of the transparency.

The laminate film of the present invention can be suitably used as a protecting film and can be particularly suitably used as a print surface-protecting film.

### [Suitability for Thermal Lamination]

The present film has excellent suitability for thermal lamination on a printed matter.

Here, the suitability for thermal lamination in the present invention can be evaluated by pasting the present film and a printed matter by causing to pass through heated nip rolls and measuring the subsequent release strength. The method for measuring the release strength is based on the method described in the Examples below.

### [Humidity and Heat Resistance]

By thermally laminating the present film on a printed matter, the humidity and heat resistance can be made excellent.

Here, the humidity and heat resistance in the present invention means that the present film and the printed matter are not separated even in a humid and hot environment and refers to retort resistance. More specifically, as described in the Examples below, a sample obtained after thermally laminating the present film and a printed matter is left still in pressurized hot steam at 120° C. for 0.5 hours, and then the appearance is observed and the humidity and heat resistance may be evaluated.

### [Thickness]

The thickness of the present film is preferably 6 μm or more and 80 μm or less, more preferably 8 μm or more and 60 μm or less, further preferably 10 μm or more and 40 μm or less. Here, the thickness of the present film is the thickness excluding the release layer when a release layer is included.

When the thickness of the present film is 6 μm or more, the transportability and the handling property during thermal lamination improve. On the other hand, when the thickness is 80 μm or less, the transparency of the present film is excellent.

Each layer will be explained below.

### 1. Base Layer

For the base layer in the present invention, a material which is generally used for a base layer can be used. Specifically, a thermoplastic resin, a thermosetting resin, a glass film, a metal foil or the like is used. Of these, a thermoplastic resin (A) is preferably contained, and the thermoplastic resin (A) is more preferably contained as the main component. When the base layer of the present film contains the thermoplastic resin (A) as the main component, higher suitability for thermal lamination is obtained.

Here, the “main component” in the present invention refers to the component which accounts for 50 mass % or more of all the components composing the layer, preferably 60 mass % or more, more preferably 70 mass % or more, further preferably 80 mass % or more, still further preferably 90 mass % or more (including 100 mass %).

### [Thermoplastic Resin (A)]

The thermoplastic resin (A) of the present invention is preferably a polyester resin or a polyolefin resin. When the base layer contains a polyester resin or a polyolefin resin, the humidity and heat resistance of the present film is more excellent.

Specific examples of the polyester resin include thermoplastic polyester resins typically including poly(ethylene glycol)terephthalate, poly(ethylene glycol)isophthalate, poly(ethylene glycol)succinate, poly(ethylene glycol)oxalate, poly(ethylene glycol)adi pate, poly(butanediol)terephthalate, poly(hexanediol)terephthalate, poly(1,4-cyclohexanedimethanol) terephthalate and copolymers thereof. One kind alone of these polyester resins or a combination of two or more kinds thereof can be used. In this regard, a copolymer thereof here means a copolymer of a polymer in which a component other than the constituent component of the polymer is co-polymerized, and the same applies below. Copolymerization may be graft polymerization or the like.

Of the above examples, poly(ethylene glycol)terephthalate is preferable because the stickiness or the tackiness of the film can be reduced and because the layer adhesion with the sealant layer and the heat resistance are excellent.

Specific examples of the polyolefin resin include polyethylene, polypropylene, polymethylpentene and copolymers thereof typically including poly(ethylene-vinyl acetate) copolymer and maleic acid-modified polypropylene. One kind alone of these polyolefin resins or a combination of two or more kinds thereof can be used.

Of the above examples, polypropylene is preferable because the stickiness or the tackiness of the film can be reduced and because the layer adhesion with the sealant layer and the heat resistance are excellent.

The base layer may be a single layer or include multiple layers. In the case of multiple layers, each layer also preferably contains a thermoplastic resin and more preferably contains a thermoplastic resin as the main component. Moreover, as the thermoplastic resin in each layer, a polyolefin resin or a polyester resin is preferably used.

A polyolefin resin and a polyester resin may be used in combination for the base layer. For example, multiple base layers may have both a layer containing a polyolefin resin as the main component and a layer containing a polyester resin as the main component.

The base layer of the present invention may contain an additive such as a plasticizer and a curing agent in addition to the thermoplastic resin (A).

Moreover, the base layer may be an unoriented film or a uniaxially oriented or biaxially oriented film.

### [Thickness]

The thickness of the base layer is preferably 5 μm or more and 50 μm or less, more preferably 7 μm or more and 40 μm or less, further preferably 8 μm or more and 30 μm or less.

When the thickness of the base layer is 5 μm or more, the transportability and the handling property during thermal lamination are excellent. On the other hand, when the thickness is 50 μm or less, the transparency of the present film is excellent.

### 2. Sealant Layer

The sealant layer in the present invention is composed of a resin composition and further contains a crosslinker (C). In the first embodiment of the present invention, the sealant layer is composed of a resin composition containing a thermoplastic elastomer (B) as the main component, and the thermoplastic elastomer (B) contains a styrene unit. In the second embodiment of the present invention, the sealant layer is composed of a resin composition which satisfies (1) and (2) below.
(1) The storage modulus at 50° C. is 2.0×10⁶ Pa or more and 5.0×10⁷ Pa or less.
(2) The slope of the storage modulus at 60 to 70° C. is 9.5×10⁻² or less.

Because the sealant layer is composed of a resin composition containing the thermoplastic elastomer (B) as the main component or is composed of a resin composition which satisfies (1) and (2) above, the humidity and heat resistance is excellent. More specifically, regarding the viscoelasticity behavior of a general thermoplastic resin, it is known that the shape-maintaining property is poor around the temperature range in which thermal processing such as heat sealing is possible because the elastic modulus decreases rapidly after melting. On the other hand, a material having a rubber component such as a thermoplastic elastomer has viscoelasticity behavior with a relatively gradual rubbery plateau and has a characteristic that the elastic modulus is high enough to maintain the shape to some extent even in a temperature range in which thermal processing such as heat sealing is possible, and these are useful characteristics in the present invention in which both heat-sealing property and heat resistance should be achieved.

Because the sealant layer further contains a crosslinker (C), when the print surface formed with a liquid toner and the sealant layer come into contact, the ionic group of the liquid toner component and the crosslinker (C) react with each other. Thus, the adhesion of the sealant layer and the printed matter improves, and the humidity and heat resistance becomes excellent. Moreover, because the polar group of the thermoplastic elastomer (B) and the crosslinker (C) react with each other due to the heat, the thermoplastic elastomer is cross-linked, and the molecular weight becomes large. Furthermore, the crosslinker (C) is prevented from bleeding out, and thus the suitability for thermal lamination of the present film is excellent.

The thermoplastic elastomer (B) content of the sealant layer is preferably 50 mass % or more of the total mass of the sealant layer, more preferably 70 mass % or more. On the other hand, the content is preferably 99 mass % or less, more preferably 98 mass % or less.

The crosslinker (C) content of the sealant layer is preferably 1 mass % or more of the total mass of the sealant layer, more preferably 2 mass % or more. On the other hand, the content is preferably 30 mass % or less, more preferably 20 mass % or less.

Regarding the ratio of the thermoplastic elastomer (B) and the crosslinker (C) contained in the sealant layer, in view of the humidity and heat resistance, the ratio of the crosslinker (C) to the thermoplastic elastomer (B) is preferably 0.01 or more, more preferably 0.02 or more. On the other hand, in view of the thermal lamination property, the ratio is preferably 0.4 or less, more preferably 0.25 or less.

### [Resin Composition]

In the first embodiment of the present invention, the resin composition composing the sealant layer contains the thermoplastic elastomer (B) as the main component. In the second embodiment of the present invention, the resin composition composing the sealant layer satisfies (1) and (2) below.
(1) The storage modulus at 50° C. is 2.0×10⁶ Pa or more and 5.0×10⁷ Pa or less.
(2) The slope of the storage modulus at 60 to 70° C. is 9.5×10⁻² or less.

In the second embodiment of the present invention, the resin composition composing the sealant layer also preferably contains the thermoplastic elastomer (B) and preferably contains the thermoplastic elastomer (B) as the main component.

The thermoplastic elastomer (B) content (in terms of solid content) of the resin composition composing the sealant layer is preferably 50 mass % or more and 100 mass % or less, more preferably 60 mass % or more and 95 mass % or less, further preferably 70 mass % or more and 90 mass % or less.

When the thermoplastic elastomer (B) content is 50 mass % or more, the humidity and heat resistance is excellent. On the other hand, when the content is 100 mass % or less, the winding property of the present film is excellent.

The storage modulus at 50° C. of the resin composition composing the sealant layer is preferably 2.0×10⁶ Pa or more and 5.0×10⁷ Pa or less. In the above range, a film having excellent adhesiveness and reliability when used as a packing material is obtained. In view of the adhesion strength, the storage modulus is more preferably 3.0×10⁶ Pa or more, further preferably 4.0×10⁶ Pa or more. On the other hand, in view of the heat-sealing property, the storage modulus is more preferably 4.0×10⁷ Pa or less, further preferably 3.0×10⁷ Pa or less.

The storage modulus at 50° C. of the resin composition composing the sealant layer can be determined by the method described in the Examples below.

The slope of the storage modulus at 60 to 70° C. of the resin composition composing the sealant layer is preferably 9.5×10⁻² or less. In the above range, the change in the elastic modulus of the resin composition is gradual relative to the temperature change, and thus the suitability for thermal lamination and the humidity and heat resistance can be both achieved. To broaden the suitability for processing temperature of the film, the slope is more preferably 9.0×10⁻² or less, further preferably 8.5×10⁻² or less.

The slope of the storage modulus at 60 to 70° C. of the resin composition composing the sealant layer can be determined by the method described in the Examples below.

The flow start temperature of the resin composition of the present invention is preferably 80° C. or higher and 105° C. or lower, more preferably 83° C. or higher and 102° C. or lower, further preferably 85° C. or higher and 100° C. or lower.

When the flow start temperature is 80° C. or higher, the humidity and heat resistance is excellent. On the other hand, when the flow start temperature is 105° C. or lower, the suitability for thermal lamination is excellent.

The flow start temperature of the resin composition of the present invention is measured by the method described below. The flow start temperature of the resin composition of the present invention can be adjusted by appropriately selecting the kind of the thermoplastic elastomer (B) and/or the crosslinker (C).

The flow start temperature of the resin composition of the present invention can be measured using a Koka flow tester “CFT-500D” manufactured by Shimadzu Corporation. For the measurement, a nozzle of 1 mmφ×2 mmL is used, and the load is 40 kg/cm². The process in which the test piece which is heated at a rate of 3° C./minute reaches the fluid area from solid through rubber-like elasticity area is continuously measured, and the temperature at which the test piece flows from the nozzle is determined.

### [Thermoplastic Elastomer (B)]

In the first embodiment of the present invention, the thermoplastic elastomer (B) contains a styrene unit. The “styrene unit” in the present invention means a repeating unit obtained when styrene is polymerized.

In the first embodiment of the present invention, the thermoplastic elastomer (B) is preferably a copolymer containing a styrene unit, more preferably a copolymer containing a styrene unit and any repeating unit which is not a styrene unit. When the thermoplastic elastomer (B) is a copolymer containing a styrene unit and any repeating unit which is not a styrene unit, the styrene polymerization proportion is preferably 5 mass % or more in view of the solubility in a solvent, more preferably 10 mass % or more. On the other hand, in view of the thermal lamination property, the proportion is preferably 50 mass % or less, more preferably 40 mass % or less.

The copolymers containing a styrene unit and any repeating unit which is not a styrene unit are specifically a conjugated diene polymer and a hydrogenated conjugated diene polymer, and of these, a hydrogenated conjugated diene polymer is preferable. A hydrogenated polymer has the effect of suppressing oxidative degradation.

Examples of the conjugated diene polymer containing a styrene unit include a styrene-butadiene copolymer (styrene-butadiene rubber) and a styrene-isoprene copolymer (styrene-isoprene rubber). One kind thereof may be used alone, or two or more kinds thereof may be used in combination.

Of the examples above, in view of the easiness of acquisition, the heat resistance and the film formation property, a styrene-butadiene copolymer is more preferable, and a hydrogenated styrene-butadiene copolymer is further preferable. The styrene-butadiene copolymer is further preferably a block copolymer of styrene and butadiene.

In the second embodiment of the present invention, when the resin composition composing the sealant layer contains the thermoplastic elastomer (B), the thermoplastic elastomer (B) preferably contains a styrene unit and is more preferably a copolymer containing a styrene unit, further preferably a copolymer containing a styrene unit and any repeating unit which is not a styrene unit. Preferable aspects of the copolymer containing a styrene unit and any repeating unit which is not a styrene unit are as described above.

In the second embodiment of the present invention, one which does not contain any styrene unit can also be used as the thermoplastic elastomer (B). Examples thereof include an acrylonitrile-butadiene copolymer (acrylonitrile-butadiene rubber), butadiene rubber, isoprene rubber, chloroprene rubber and copolymers thereof. One kind thereof may be used alone, or two or more kinds thereof may be used in combination.

Preferable aspects of the thermoplastic elastomer (B) in the first embodiment and the second embodiment of the present invention will be explained below.

The thermoplastic elastomer (B) of the present invention preferably has a polar group, and the polar group is preferably an acidic functional group. The acidic functional group is a group derived from a carboxylic acid, an acid anhydride, a carboxylic halide, sulfonic acid or the like but is preferably a group derived from a carboxylic acid or an acid anhydride in view of the easiness of acquisition.

When the thermoplastic elastomer (B) of the present invention has a polar group, in particular an acidic functional group, the crosslinker (C) can be prevented from bleeding out, and the suitability for thermal lamination can be made more excellent.

When the thermoplastic elastomer (B) of the present invention has an acidic functional group, the acid value thereof is preferably 1 mg CH₃ONa/g or more and 100 mg CH₃ONa/g or less, more preferably 2 mg CH₃ONa/g or more and 80 mg CH₃ONa/g or less, further preferably 3 mg CH₃ONa/g or more and 50 mg CH₃ONa/g or less.

When the acid value is 1 mg CH₃ONa/g or more, the suitability for thermal lamination is excellent. On the other hand, when the acid value is 100 mg CH₃ONa/g or less, the thermal stability is excellent.

Here, the acid value of the thermoplastic elastomer (B) of the present invention is measured in accordance with JP 2002-202301 A.

The thermoplastic elastomer (B) of the present invention is preferably an acid-modified conjugated diene polymer. It is known that, because a conjugated diene polymer has a carbon-carbon double bond in the molecular structure, an acidic functional group can be added, which means that the polymer can be acid-modified, by radically adding an unsaturated carboxylic acid (and an acid anhydride) such as acrylic acid and maleic anhydride. Of the acid modification, maleic anhydride-modification is preferable in view of the easiness of acquisition. The acid-modified conjugated diene copolymer can also be acquired as a commercial product as “Tuftec: M1911, M1913 and M1943 (Asahi Kasei Corporation)”, “Tufprene: 912 (Asahi Kasei Corporation)” or “Kraton FG polymer: FG1901 and FG1924 (Kraton Corporation)”.

In view of the humidity and heat resistance, the elastic modulus of the thermoplastic elastomer (B) of the present invention is preferably 0.5 GPa or more, more preferably 0.7 GPa or more, at a measurement temperature in the range of 100 to 110° C. On the other hand, in view of the thermal lamination property, the elastic modulus is preferably 10 GPa or less, more preferably 5 GPa or less, at a measurement temperature in the range of 100 to 110° C. The elastic modulus can be measured with a dynamic mechanical analysis (DMA) device.

The iodine value of the thermoplastic elastomer (B) of the present invention is preferably 50 or less, more preferably 30 or less. The iodine value is preferably 50 or less, because the amount of the remaining double bonds in the thermoplastic elastomer is sufficiently low, and the physical deterioration due to oxidation can be prevented.

The iodine value can be measured according to JIS K0070-1992.

### [Crosslinker (C)]

The sealant layer of the present invention further contains a crosslinker (C). The crosslinker (C) is an epoxy crosslinker, a carbodiimide crosslinker, a peroxide, a vinyl compound, an acrylate or the like but is preferably an epoxy crosslinker in view of the reactivity and the stability.

When the crosslinker (C) of the present invention is an epoxy crosslinker, the average functional group number of the epoxy group per molecule of the epoxy crosslinker is preferably 1.5 or more. When the average functional group number of the epoxy group per molecule is 1.5 or more, the retort resistance can be improved.

The average functional group number of the epoxy group per molecule can be determined by dividing the average molecular weight by the epoxy equivalent. The average molecular weight can be measured by gas chromatography-mass spectrometry or high-performance liquid chromatography, and the epoxy equivalent can be measured by the measurement method specified in JIS K7236:2001.

The average functional group number of the epoxy group per molecule is preferably 1.5 or more as described above, more preferably 1.7 or more, further preferably 2 or more. On the other hand, the number is preferably 50 or less, more preferably 30 or less, further preferably 20 or less. When the average functional group number of the epoxy group per molecule is 50 or less, the solubility in the coating process can be improved.

As such an epoxy crosslinker, an epoxy group-containing resin or an epoxy compound can be used. The epoxy group-containing resin is specifically a (poly)glycidyl ether compound of a polyhydric alcohol such as glycerol (poly)glycidyl ether, pentaerythritol (poly)glycidyl ether and polyethylene glycol diglycidyl ether, epoxidized polybutadiene or the like. The epoxy compound is specifically an epoxidized unsaturated oil such as epoxidized soybean oil and epoxidized linseed oil or the like. One kind thereof may be used alone, or two or more kinds thereof may be used in combination.

Of these, in view of the easiness of acquisition, the heat resistance and the compatibility, glycerol (poly)glycidyl ether, pentaerythritol (poly)glycidyl ether and an epoxy compound are preferable. In view of the thermal stability, an epoxy compound is more preferable, and epoxidized soybean oil is further preferable.

Here, (poly)glycidyl ether is a concept including both monoglycidyl ether and polyglycidyl ether, and similar terms thereof have the same meanings.

The epoxy equivalent of the epoxy crosslinker is preferably 150 g/eq or more in view of the resistance to bleeding out, more preferably 180 g/eq or more. On the other hand, in view of the compatibility, the epoxy equivalent is preferably 500 g/eq or less, more preferably 480 g/eq or less, further preferably 400 g/eq or less.

The weight-average molecular weight of the epoxy crosslinker is preferably 200 or more in view of the resistance to bleeding out, more preferably 400 or more. On the other hand, in view of the compatibility, the weight-average molecular weight is preferably 3000 or less, more preferably 2000 or less.

The surface tension (SP value) of the epoxy crosslinker is preferably 8 or more in view of the compatibility, more preferably 8.5 or more. On the other hand, in view of the resistance to bleeding out, the surface tension is preferably 11 or less, more preferably 10.5 or less.

The surface tension (SP value) can be calculated by the Fedors method using the equation (1) below.

$$SP value ( solubility parameter ) = {( CED value )}^{1 / 2} = {( E / V )}^{1 / 2} \qquad ( 1 )$$

In the equation (1), E is the molecular aggregation energy (cal/mol), and V is the molecular volume (cm³/mol), which are represented by the equation (2) and the equation (3) below, where the vaporization energy of the atomic group is Δei, and the molar volume is Δvi.

$$E = ΣΔ ei \qquad ( 2 )$$

$$V = ΣΔ vi \qquad ( 3 )$$

### [Other Component]

The resin composition composing the sealant layer of the present invention may contain a reaction auxiliary, another resin, a filler, an antioxidant or the like as a component other than the thermoplastic elastomer (B) and the crosslinker (C) for the purpose of improving the reactivity, the transparency, the antiblocking property and the gelation of the sealant layer.

### [Thickness]

The thickness of the sealant layer is preferably 1 μm or more and 30 μm or less, more preferably 2 μm or more and 25 μm or less, further preferably 3 μm or more and 20 μm or less.

When the thickness of the sealant layer is 1 μm or more, the suitability for thermal lamination of the present film is excellent. On the other hand, when the thickness is 30 μm or less, the transparency of the present film is excellent.

### 3. Primer Layer

The present film preferably includes a primer layer between the sealant layer and the base layer. When the primer layer is included, the adhesion between the sealant layer and the base layer can be improved.

The primer layer is composed of a composition containing a resin as the main component, and as the main component resin, a resin which is generally used as a primer resin in the field of printing can be used. Examples thereof include polyethylenimine, polyvinyl acetate, polyacrylic acid, polyvinyl alcohol, polyvinyl acetal, polyester, polyvinyl acetamide and polyvinylpyrrolidone. Of these, in view of the solvent resistance during the formation of the sealant layer of the present invention, polyethylenimine, polyvinyl alcohol, polyvinyl acetal, polyvinylpyrrolidone and polyester are preferable, and in view of the adhesion with the sealant layer of the present invention, polyethylenimine is more preferable. One kind thereof may be used alone, or two or more kinds thereof may be used in combination.

The thickness of the primer layer is preferably 0.01 μm or more and 10 μm or less, more preferably 0.05 μm or more and 7 μm or less, further preferably 0.1 μm or more and 5 μm or less.

The thickness of the primer layer of 0.01 μm or more has an effect of reducing the optical appearance defect of the film. On the other hand, when the thickness of the primer layer is 10 μm or less, excellent adhesiveness can be obtained.

### 4. Release Layer

The present film may have a release layer on the sealant layer on the side opposite to the surface facing the base layer. When the release layer is included, a trouble in the step of winding, contamination with a foreign matter or the like can be prevented. The release layer is preferably removed when the present film is thermally laminated on a printed matter.

The release layer is not particularly limited as long as the release layer has the property of releasing the sealant layer, but examples thereof include various release films such as a fluororesin film, a polyester film coated with a release agent and a polyolefin film coated with a release agent. When a release film coated with a release agent is used, the surface coated with the release agent is preferably in contact with the sealant layer.

The thickness of the release layer is preferably 10 μm or more and 100 μm or less, more preferably 15 μm or more and 80 μm or less, further preferably 20 μm or more and 60 μm or less.

When the thickness of the release layer is 10 μm or more and 100 μm or less, the release layer can be easily removed during the thermal lamination with a printed matter.

### 5. Production Method of Present Film

An example of the method for producing a laminate film in the present invention will be explained below, but the present invention is not limited only to the laminate film produced by the production method.

The present film is formed by a coextrusion method, a lamination method, a coating and drying method or the like but is preferably formed by a coating and drying method in terms of the continuous productivity.

When the present film is produced by a coating and drying method, as the solvent for the coating solution, a solvent capable of dissolving or dispersing the resin composition composing the sealant layer evenly and stably is preferably used.

Examples of such a solvent include petroleum benzine, toluene, xylene, benzene, ethylbenzene, hexane, cyclohexane, limonene, decalin, tetralin, chloroform and tetrahydrofuran.

Of the solvents, toluene and limonene are preferable in view of the solubility and the volatility.

The coating style of the coating and drying method is not particularly limited as long as the style can achieve the required layer thickness and the coating area. Examples of such a coating method include a gravure coater method, a small gravure coater method, a reverse roll coater method, a transfer roll coater method, a kiss coater method, a dip coater method, a knife coater method, an air doctor coater method, a blade coater method, a rod coater method, a squeeze coater method, a cast coater method, a die coater method, a screen printing method and a spray coating method.

In the coating and drying process, a release film can be introduced for the purpose of preventing adhesion or blocking of the sealant layer. In a more specific method, after the coating process and the drying process, just before winding, a release film is placed on the sealant layer and combined in the winding process. By the method, troubles during winding and transfer can be reduced, and adhesion of a foreign matter can be prevented. The release film preferably serves as the release layer in the present film.

### <Multilayer Body>

In the present invention, the laminate film is preferably used by laminating on a print layer. The laminate film can be laminated on the print layer by thermal lamination. At this point, the sealant layer of the laminate film preferably faces the print layer. That is, the sealant layer and the print layer are preferably in contact with each other.

A third embodiment of the present invention is a multilayer body having a laminate film having at least a base layer and a sealant layer and a print layer. In the multilayer body, the sealant layer and the print layer are in contact with each other, and the sealant layer contains a crosslinker. The print layer contains a liquid toner, and the liquid toner contains a polymer having an ionic group. The multilayer body has a cross-linked structure of the crosslinker and the ionic group.

The laminate film of the present invention has excellent suitability for thermal lamination, and thus a multilayer body (also referred to as “multilayer film” below) can be easily obtained by thermally laminating the laminate film on a printed matter having a print layer. Here, the multilayer body has the laminate film and a print layer. This means that the multilayer body has a base layer, a sealant layer and a print layer in this order. The print layer is generally formed on the surface of a printed matter, and thus the multilayer body is preferably formed on the surface of the printed matter.

The humidity and heat resistance of the laminate film of the present invention can be made excellent because the crosslinker (C) contained in the sealant layer reacts with the liquid toner component, specifically the ionic group of the polymer having the ionic group contained in the liquid toner, and thus forms a cross-linked structure, and thus the laminate film of the present invention can be suitably used when the print layer is formed with a liquid toner. The print layer is preferably formed, for example, by printing with a liquid toner using a known printer and appropriately drying.

The liquid toner preferably contains a polymer having an ionic group or more preferably contains a polymer having an ionic group capable of reacting with a cyclic ether group such as epoxy group, and of these, a carboxy group-containing polymer is further preferably contained.

When the liquid toner contains a carboxy group-containing polymer, the reactivity with the crosslinker (C), especially with an epoxy crosslinker, is high, and thus the laminate film of the present invention can be more suitably used.

The printed matter in the present invention is not particularly limited and may be any of a paper material, a film material, a cloth material and the like, and the print layer is preferably formed on the surface thereof. The print layer may be formed on a primer layer formed on the surface of the printed matter. The film material is preferably composed of a single resin film, a laminate film having two layers or more including a resin film or the like.

The multilayer body of the present invention is preferably used for a packaging material for packaging various articles. For example, as described above, the printed matter in which the multilayer body is formed on the surface is preferably used as a packaging material. The multilayer body of the present invention has excellent humidity and heat resistance, thus has excellent retort suitability and can be suitably used as a packaging film. Here, in the packaging film, the film material is the printed matter. Moreover, the packaging material such as a packaging film is more preferably used for retort purpose.

The packaged article of the present invention is obtained by packaging an article such as a beverage, a food and an article of daily use or a container containing an article with the packaging material above. The packaging form is not particularly limited. An article may be contained in the packaging material in the form of a bag, a container or the like, or an article or a container containing an article may be partially or entirely wrapped in the packaging material.

In the present invention, the expression “X to Y” (X and Y are numbers) includes the meaning “X or more and Y or less” and the meaning “preferably larger than X” and “preferably smaller than Y” unless otherwise specified.

Moreover, in the present invention, the expression “X or more” (X is a number) includes the meaning “preferably larger than X” unless otherwise specified, and the expression “Y or less” (Y is a number) includes the meaning “preferably smaller than Y” unless otherwise specified.

### EXAMPLES

The present invention will be explained more specifically below with Examples and Production Examples. However, the present invention is not limited to the Examples and the Production Examples below, and various modifications can be made unless departing from the gist of the present invention.

### <Measurement and Evaluation Methods>

### (1) Thickness

The thicknesses of the base layer, the release layer and the laminate film were determined from the averages of five random points measured with a 1/1000 mm dial gage. The results are shown in Table 1.

The thickness of the sealant layer was calculated by subtracting the thicknesses of the base layer and the release layer from the thickness of the laminate film.

### (2) Storage Modulus of Resin Composition

The storage modulus of the resin composition composing the sealant layer of the present invention was obtained by producing a film composed solely of the resin composition and conducting dynamic mechanical analysis. In the dynamic mechanical analysis, a sample piece in a strip shape cut out with a width of 4 mm and a length of 35 mm was measured at a measurement frequency of 1 Hz, a measurement strain of 0.1% and a chuck distance of 25 mm while heating at a heating rate of 3° C./min from a measurement temperature of −100° C.

Here, in the dynamic mechanical analysis, by measuring the thickness of the sample piece in advance and inputting the thickness of the sample piece and the width of the sample piece in the analyzer, the sectional area of the sample piece is calculated, and the values are calculated. In the Examples, a viscoelastic spectrometer DVA-200 (manufactured by IT Keisoku Seigyo Kabushikigaisha) was used as the analyzer.

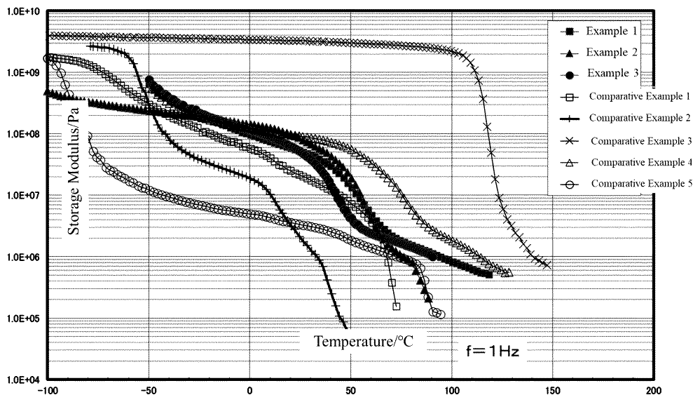

The results of the plots of the Examples and the Comparative Examples, where the vertical axis is the storage modulus and the horizontal axis is the temperature, are shown in FIG. 1. Moreover, the storage moduli at 50° C. and the slopes of the storage modulus at 60 to 70° C. are shown in Table 1.

Regarding the storage modulus at 50° C., when there was a point of measurement at a temperature of 50° C. (49.6° C. to 50.4° C.) in the measurement above, the storage modulus at the point was regarded as “the storage modulus at 50° C.”. When there was no point of measurement in the temperature range, the average of the storage moduli of the two points of measurement at the temperatures closest to the temperature range was regarded as “the storage modulus at 50° C.”. In Comparative Example 2, because the maximum value in the measurement temperature range was 48.4° C. (the storage modulus at the point: 5.9×10⁴ Pa), “the storage modulus at 50° C.” is regarded as “less than 5.9×10⁴ Pa” and shown in Table 1.

The slope of the storage modulus at 60 to 70° C. was calculated by the following equation, when there were a point of measurement at a temperature of 60° C. (59.6° C. to 60.4° C.) and a point of measurement at a temperature of 70° C. (69.6° C. to 70.4° C.).

$$( Slope ) = \vert {log}_{10} ( storage modulus at 60 ° C . ) - {log}_{10} ( storage modulus at 70 ° C . ) ) / ( 60 - 70 ) \vert$$

When there were no points of measurement at temperatures of 60° C. and 70° C., the slope was calculated by the above equation using the averages of the storage moduli of the two points of measurement at the temperatures closest to the temperatures as “the storage modulus at 60° C.” and “the storage modulus at 70° C.”. In Comparative Example 2, because the maximum value in the measurement temperature range was 48.4° C., the slope could not be calculated.

### (3) Suitability for Thermal Lamination

Regarding a multilayer film after thermal lamination, the release strength of the sealant layer of the present film and a printed matter sample was measured by the following method, and the suitability for thermal lamination was evaluated with the following evaluation criteria. The evaluation results are shown in Table 1.
AA (very good): release strength of 3 N/15 mm or more
A (good): release strength of 2 N/15 mm or more and less than 3 N/15 mm
B (poor): release strength of less than 2 N/15 mm

### [Measurement of Release Strength]

In accordance with JIS Z0237, regarding a multilayer film after thermal lamination, the release strength of the present film and a printed matter sample was measured. First, a printed matter sample on which the present film was thermally laminated was cut out with a width of 50 mm×a length of 150 mm as the sample, and cellophane tape (manufactured by NICHIBAN Co., Ltd., JIS Z1522) was pasted in the lengthwise direction on the surface of the present film of the sample. The sample was folded at 90° in such a manner that the back side of the tape faced each other, and 25 mm was removed from the sample. Next, the end of the removed part of the sample was fixed on the bottom chuck of a tensile tester (manufactured by INTESCO co., ltd., Intesco IM-20ST), and the tape was fixed on the top chuck. The removing strength was measured at a test rate of 300 mm/minute. After the measurement, the measured values of the first 25 mm in the length were ignored, and the average of the measured values of the removing strength of the 50 mm in the length removed from the test piece was determined and regarded as the release strength. Here, when the present film was not removed but the tape alone was removed, the release strength of the present film was considered as the release strength of the tape alone or more.

### (4) Humidity and Heat Resistance (Retort Resistance)

A printed matter sample on which the present film was thermally laminated was treated in high-pressure steam set at 120° C. for 0.5 hours using a pressure cooker tester (manufactured by Espec Corp.: EHS-411M), and the appearance after the treatment was evaluated by the following criteria. The evaluation results are shown in Table 1.
A (good): No removal was found on the entire film surface.
B (poor): A part was removed.

### <Materials>

### [Base Layer]

### (Thermoplastic Resin (A))

A-1: Corona-treated biaxially oriented polyester film (thickness of 12 μm, product name “Diafoil H600C”, manufactured by Mitsubishi Chemical Corporation)

### [Sealant Layer]

### (Thermoplastic Elastomer (B))

B-1: Hydrogenated styrene-butadiene elastomer (product name “Tuftec M1913”, manufactured by Asahi Kasei Corporation, acid value of 10 mg CH₃ONa/g)
B-2: Styrene-butadiene elastomer (product name “Tufprene 912”, manufactured by Asahi Kasei Corporation, acid value of 3.2 mg CH₃ONa/g)
B-3: Olefin elastomer (product name “EXCELINK3400N”, manufactured by ENEOS Materials Corporation)

### (Thermoplastic Resin (B′))

B′-4: LLDPE resin (product name “Modic M545”, manufactured by Mitsubishi Chemical Corporation, acid value of 7.4 mg CH₃ONa/g)
B′-5: Polypropylene resin (product name “Auroren 350S”, manufactured by Nippon Paper Chemicals Co., Ltd., acid value of 40 mg CH₃ONa/g)
B′-6: Maleic anhydride-styrene copolymer (product name: “SMA EF80”, manufactured by CRAY VALLEY, acid value of 120 mg CH₃ONa/g)

### (Crosslinker (C))

C-1: Epoxidized soybean oil (epoxy crosslinker, product name: “ADK CIZER O-130P”, average functional group number of epoxy group per molecule of 3.85, manufactured by ADEKA CORPORATION)
C-2: Pentaerythritol polyglycidyl ether (epoxy crosslinker, product name: “Denacol EX-411”, average functional group number of epoxy group per molecule of 1.56, manufactured by Nagase ChemteX Corporation)

### [Release Layer]

D-1: Release polyester film (release PET, thickness of 38 μm, product name “Diafoil MRF-38”, manufactured by Mitsubishi Chemical Corporation)

### Example 1

On one surface of the base layer A-1, polyethylenimine (product name: “Epomin P1000”, manufactured by Nippon Shokubai Co., Ltd.) at a weight content resulting in 0.15 g/m² was coated using a gravure roller and then dried, and thus a primer layer was formed.

Subsequently, 20 parts by mass of the thermoplastic elastomer B-1 and two parts by mass of the crosslinker C-1 were dissolved in 80 parts by mass of toluene, and thus a coating solution was obtained. The coating solution was coated on the primer layer to a WET thickness of 20 μm and dried at 90° C. for 10 minutes, and after drying, the coated surface was layered on the release layer D-1 to face the release surface. Thus, the multilayer film of Example 1 was obtained.

### [Production of Printed Matter Sample]

A nylon film (product name: “Harden N1200”, manufactured by Toyo Boseki, thickness of 15 μm) and an unoriented polypropylene film (product name: “FRTK-G”, manufactured by Futamura Chemical Co., Ltd., thickness of 50 μm) were pasted in this order by dry lamination, and thus a laminate film was obtained.

For pasting by dry lamination, a urethane adhesive (product name: “Takelac A-515V/Takenate A-5”, manufactured by Mitsui Chemicals, Inc.) was used and coated with a gravure printing plate in such a manner that the coated amount after drying became 3.5 g/m². After pasting, aging at 40° C. for 48 hours was conducted. Then, the nylon film side was subjected to corona treatment, and polyethylenimine (product name: “Epomin P1000”, manufactured by Nippon Shokubai Co., Ltd.) was used as a primer and coated using a gravure roller in such a manner that the entire surface of the nylon film side would be covered with the polyethylenimine in the weight of 0.15 g/m². Subsequently, a print layer was printed on the entire surface coated with the primer of the laminate film with HP Indigo electroink in magenta using a HP Indigo 6600 digital printer. Thus, a printed matter sample was obtained.

### Example 2

The multilayer film of Example 2 was obtained in the same manner as in Example 1 except that the thermoplastic elastomer B-1 of the sealant layer was changed to the thermoplastic elastomer B-2.

### Example 3

The multilayer film of Example 3 was obtained in the same manner as in Example 1 except that the crosslinker C-1 of the sealant layer was changed to the crosslinker C-2.

### Comparative Example 1

The multilayer film of Comparative Example 1 was obtained in the same manner as in Example 1 except for the following points: the thermoplastic elastomer B-1 of the sealant layer was changed to the thermoplastic resin B′-4; the solvent was changed from toluene to xylene; and the drying conditions were changed to vacuum drying at normal temperature for 24 hours and then drying at 90° C. for 10 minutes.

### Comparative Example 2

The multilayer film of Comparative Example 2 was obtained in the same manner as in Example 1 except that the thermoplastic elastomer B-1 of the sealant layer was changed to the thermoplastic resin B′-5.

### Comparative Example 3

The multilayer film of Comparative Example 3 was obtained in the same manner as in Example 1 except that the thermoplastic elastomer B-1 of the sealant layer was changed to the thermoplastic resin B′-6.

### Comparative Example 4

The multilayer film of Comparative Example 4 was obtained in the same manner as in Example 1 except that the crosslinker C-1 was not added to the sealant layer.

### Comparative Example 5

A hundred parts by mass of the thermoplastic elastomer B-3 and 10 parts by mass of the crosslinker C-1 were each preheated at 200° C. for three minutes using a Labo Plastomill (4C150, manufactured by Toyo Seiki Seisaku-sho, Ltd.) and kneaded at a rotation rate of 50 rpm in a filling amount of 70 g for 10 minutes. Thus, a resin composition was obtained.

On one surface of the base layer A-1, polyethylenimine (product name: “Epomin P1000”, manufactured by Nippon Shokubai Co., Ltd.) at a weight content resulting in 0.15 g/m² was coated using a gravure roller and then dried, and thus a primer layer was formed.

The melted resin composition was put on the primer layer side of the A-1 film, and the D-1 film was placed in such a manner that the release surface was facing thereto. By causing to pass through a metal roll set at 180° C. and a rubber roll, the multilayer film of Comparative Example 5 was obtained.

TABLE 1

| Example | Example | Example | Comparative | Comparative | Comparative | Comparative | Comparative |
|---|---|---|---|---|---|---|---|
| 1 | 2 | 3 | Example 1 | Example 2 | Example 3 | Example 4 | Example 5 |

Base Layer

| | | | | | | | | |
|---|---|---|---|---|---|---|---|---|
| Thermoplastic | A-1 | A-1 | A-1 | A-1 | A-1 | A-1 | A-1 | A-1 |
| Resin | | | | | | | | |
| Thickness of | 12 | 12 | 12 | 12 | 12 | 12 | 12 | 12 |
| Base Layer (μm) | | | | | | | | |

Sealant Layer

| | | | | | | | | |
|---|---|---|---|---|---|---|---|---|
| Thermoplastic | B-1 | B-2 | B-1 | — | — | — | B-1 | B-3 |
| Elastomer | | | | | | | | |
| Thermoplastic | — | — | — | B′-4 | B′-5 | B′-6 | — | — |
| Resin | | | | | | | | |
| Thickness of | 5 | 5 | 5 | 5 | 5 | 5 | 5 | 5 |
| Sealant Lyer | | | | | | | | |
| (μm) | | | | | | | | |
| Crosslinker | C-1 | C-1 | C-2 | C-1 | C-1 | C-1 | — | C-1 |
| Release Layer | Release | Release | Release | Release | Release | Release | Release | Release |
| | PET | PET | PET | PET | PET | PET | PET | PET |
| Thickness of | 38 | 38 | 38 | 38 | 38 | 38 | 38 | 38 |
| Release Layer | | | | | | | | |
| (μm) | | | | | | | | |
| Storage Modulus | 1.5 × 10⁷ | 1.9 × 10⁷ | 4.3 × 10⁶ | 7.3 × 10⁶ | Less than | 3.0 × 10⁹ | 5.5 × 10⁷ | 1.8 × 10⁶ |
| at 50° C. (Pa) | | | | | 5.9 × 10⁴ | | | |
| Slope of Storage | 3.3 × 10⁻² | 4.7 × 10⁻² | 1.1 × 10⁻² | 9.8 × 10⁻² | Not | 1.6 × 10⁻³ | 3.1 × 10⁻² | 1.1 × 10⁻² |
| Modulus at 60 to | | | | | calculable | | | |
| 70° C. | | | | | | | | |
| Release Strength | 3.3 | 2.8 | 3.1 | 0 | 2.3 | 0 | 2.8 | 0.4 |
| (N/15 mm) | | | | | | | | |
| Suitability for | AA | A | AA | B | A | B | A | B |
| Thermal | | | | | | | | |
| Lamination | | | | | | | | |
| Retort | A | A | A | — | B | — | B | B |
| Resistance | | | | | | | | |

From Table 1, laminate films having excellent suitability for thermal lamination and excellent humidity and heat resistance (retort resistance) were obtained in Examples 1 to 3.

On the other hand, it was difficult in Comparative Examples 1 to 5 to achieve both suitability for thermal lamination and retort resistance. In Comparative Example 1 and Comparative Example 3, because the suitability for thermal lamination was poor, the retort resistance could not be evaluated.

1. A laminate film comprising
at least a base layer and a sealant layer,
wherein the sealant layer is composed of a resin composition containing a thermoplastic elastomer (B) as the main component,
the thermoplastic elastomer (B) contains a styrene unit, and
the sealant layer further contains a crosslinker (C).

2. A laminate film comprising
at least a base layer and a sealant layer,
wherein the sealant layer is composed of a resin composition which satisfies (1) and (2) below,
(1) the storage modulus at 50° C. is 2.0×10⁶ Pa or more and 5.0×10⁷ Pa or less, and
(2) the slope of the storage modulus at 60 to 70° C. is 9.5×10⁻² or less.

3. The laminate film according to claim 2, wherein the resin composition contains a thermoplastic elastomer (B).

4. The laminate film according to claim 2, wherein the sealant layer further contains a crosslinker (C).

5. The laminate film according to claim 1, wherein the base layer contains a thermoplastic resin (A).

6. The laminate film according to claim 1, wherein the crosslinker (C) is an epoxy crosslinker.

7. The laminate film according to claim 3, wherein the thermoplastic elastomer (B) content of the resin composition is 50 mass % or more and 100 mass % or less.

8. The laminate film according to claim 1, wherein the thickness of the base layer is 5 μm or more and 50 μm or less.

9. The laminate film according to claim 1, wherein the thickness of the sealant layer is 1 μm or more and 30 μm or less.

10. The laminate film according to claim 5, wherein the thermoplastic resin (A) is at least one kind selected from the group consisting of a polyester resin and a polyolefin resin.

11. The laminate film according to claim 3, wherein the thermoplastic elastomer (B) has an acidic functional group and has an acid value of 1 mg CH₃ONa/g or more and 100 mg CH₃ONa/g or less.

12. The laminate film according to claim 1, wherein the thermoplastic elastomer (B) is a hydrogenated conjugated diene polymer.

13. The laminate film according to claim 12, wherein the conjugated diene polymer is styrene-butadiene rubber or styrene-isoprene rubber.

14. The laminate film according to claim 1 which has a primer layer between the sealant layer and the base layer.

15. A multilayer body comprising the laminate film according to claim 1 and a print layer, wherein the laminate film is thermally laminated on the print layer.

16. The multilayer body according to claim 15, wherein the print layer is formed with a liquid toner.

17. The multilayer body according to claim 16, wherein the liquid toner contains a carboxy group-containing polymer.

18. A multilayer body comprising
a laminate film having at least a base layer and a sealant layer and a print layer,
wherein the sealant layer and the print layer are in contact with each other,
the sealant layer contains a crosslinker,
the print layer contains a liquid toner,
the liquid toner contains a polymer having an ionic group, and
the multilayer body has a cross-linked structure of the crosslinker and the ionic group.

19. A packaging material comprising the multilayer body according to claim 15.

20. A packaged article packaged with the packaging material according to claim 19.
